(19) United States
(12) Patent Application Publication
(10) Pub. No.: US 2017/0080905 A1
(43) Pub. Date: Mar. 23, 2017

(54) MOBILE WORK MACHINE, ESPECIALLY TRUCK-MOUNTED CONCRETE PUMP COMPRISING SUPPORTS

(71) Applicant: Putzmeister Engineering GmbH, Aichtal (DE)

(72) Inventors: Dietmar Fügel, Wolfschlugen (DE); Christian Hahn, Böblingen (DE); Benjamin Stegmeier, Engstingen (DE)

(21) Appl. No.: 15/364,479

(22) Filed: Nov. 30, 2016

Related U.S. Application Data
(63) Continuation of application No. PCT/EP2015/060841, filed on May 18, 2015.

(30) Foreign Application Priority Data
Jun. 4, 2014 (DE) 10 2014 210 573.0

(51) Int. Cl. B60S 9/02; E04G 21/04

(52) U.S. Cl. CPC B60S 9/02; E04G 21/0445; E04G 21/0436

(57) ABSTRACT

The invention relates to a mobile work machine, in particular a truck-mounted concrete pump, comprising a vehicle-mounted support structure and at least one swivel arm that is hinged to the support structure and is provided with two bearing brackets which project like forks and are mounted by means of a supporting bore so as to be able to rotate horizontally on a swivel arm bolt retained on the support structure. According to the invention, the bearing region between the swivel arm bolt and the bearing brackets is sealed by flexible profiled ring seals.

### RELATED APPLICATIONS

This application is a continuation of PCT/EP2015/060841, filed May 18, 2015, which claims priority to DE 10 2014 210 573.0, filed Jun. 4, 2014, both of which are hereby incorporated herein by reference in their entireties.

### BACKGROUND

The invention relates to a mobile work machine, in particular a truck-mounted concrete pump, comprising a supporting structure fixed to a vehicle, in particular for a concrete distribution mast, and at least one swivel leg which is hinged to the supporting structure and has two bearing brackets which protrude in the manner of forks and are each mounted by means of a bearing bore, so as to be able to rotate horizontally, on a swivel leg bolt held on the supporting structure.

The hinging of the swivel legs onto mast blocks of truck-mounted concrete pumps resembles in its structure two links of a bicycle chain which are connected together via a bolt. Thus the swivel leg forms one “chain link” and the supporting structure the other. The swivel leg bolt connects the two parts together such that the legs can swivel out laterally about the vertical bolt axis. In contrast to a bicycle chain, the articulated connection of the swivel leg and supporting structure is loaded transversely to the connection, i.e. in the vertical direction, by transverse forces and moments. In the travelling state, the swivel leg lies on its lower bearing bracket, wherein a gap appears in the bearing region of the upper bearing bracket, while in the supporting state the reverse applies. Also, on swiveling and in pumping mode, radial and axial movements occur in the bearing region. This requires stable and precise fits which can be achieved via correspondingly machined bearing points, in some cases using bearing bushes. The bearing points lie in an exposed region where they are not protected from weather influences and corrosive media such as precipitation water and splash water during travelling or from the use of high pressure cleaners. The problem of corroded bearing points has been known for a long time, but so far no remedy has been found.

### SUMMARY

This disclosure further improves work machines known from the prior art, and with simple measures create a reliable protection for the bearing points of swivel legs.

This disclosure is based on the concept of using commercial sealing elements to protect the bearing points from the ingress of corrosive media. Consequently, according to this disclosure it is proposed that the bearing region between the swivel leg bolt and the bearing brackets is sealed by flexible profiled ring seals. Although the use of sealing elements initially appears unfeasible because of the particular peripheral conditions, surprisingly, problems could be overcome and a configuration of elastic profiled ring seals created which is adapted to the environmental and installation conditions, the functional capacity of which is not adversely affected by aggressive ambient media, so as to provide a sustained and low-maintenance functionality. Because of the flexibility of the elastic profiled ring seals, installation is easily possible without the use of special tools.

Advantageously, the elastically deformable profiled ring seals are held under pretension in a respective sealing ring seat, so as to retain a position adapted to the sealing gaps occurring, even during movements.

One embodiment provides that at least one profiled ring seal is held on each bearing bracket in a peripheral recess of the swivel leg bolt. This groove-like sealing ring seat is thus formed on the bolt and not on the bearing bracket, so that a compact construction is achieved and the bearing surface of the bearing brackets for the necessary force absorption is not restricted.

The bearing region is formed by a cylindrical bearing gap between the bearing bracket and the swivel leg bolt. This results in an exposed bearing point which is reliably sealed on both sides of the bearing bracket by the profiled ring seals.

In order to optimize the gap seal, in particular on axial bearing movements and also in the case of production tolerances, it is favorable if a V-ring as a profiled ring seal is arranged on each of the mutually facing insides of the bearing brackets. The pretensioned V-seal absorbs axial movements of the bolt and nonetheless seals this against the bearing bracket. It is particularly favorable if the V-ring has a sealing lip which can be pressed against the bearing bracket.

In order to maintain the sealing effect under widely varying conditions of use, it is advantageous if a sealing ring seat which widens conically towards a respective bearing bracket is formed on each end portion of the swivel leg bolt. The conical shape allows the V-ring to lie optimally in the seat, wherein because of the conically increasing diameter and the associated pretension, the sealing effect in the direction of the bearing point to be sealed is constantly increased.

A further improvement in retaining the desired sealing position can be achieved if the conical sealing ring seat has a stepped edge on its flank facing away from the associated bearing bracket.

For protection and design reasons, the swivel leg bolt is coated with a paint coating, wherein damage to the painted parts can advantageously be avoided if the paint coating ends at a paint edge in the region of the conical sealing ring seat, so that the paint edge remains protected from flaking off, and the unpainted region is protected from corrosion by the V-ring.

According to a further embodiment, an O-ring as a profiled ring seal is arranged on the outsides of the bearing brackets facing away from each other. Surprisingly, by use of an O-ring which is normally used only as a static seal, under the conditions of use occurring in a truck-mounted concrete pump, nonetheless a good axial and radial sealing effect can be achieved. Here it is particularly favorable if the swivel leg bolt is held at both ends on two retaining plates fixed to the vehicle, and if the O-ring is arranged in each case between the paired adjacent retaining plates and bearing brackets. Thus a reliable seat can be achieved even in the restricted installation space.

A further improvement in this regard can be achieved if the retaining plates and bearing brackets are supported against each other in pairs by sliding disks, and a gap region between the sliding disks is sealed by the O-ring.

To further improve the centering at the sealing gap, it is advantageous if the sliding disks are chamfered on their mutually adjacent peripheral edges, and in the chamfer region form a sealing ring seat for the O-ring.

Advantageously, a bearing bushing sealed by the profiled ring seals against the ingress of corrosive media is inset into the bearing bore of the bearing brackets.

With a view to cost-efficient design with nonetheless unrestricted functional capacity, it is advantageous if the swivel leg bolt comprises two cylindrical end portions and a center portion that widens as a double cone towards the end portions, and a profiled ring seal is arranged in each of the transitional regions between the center portion and the end portions.

In order to further increase the benefits in use by suitable choice of material, the profiled ring seals should be formed from a nitrile rubber.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 shows a swivel leg of a truck-mounted concrete pump with a hinge connection to a supporting structure fixed to the vehicle, as a partly cut-away side view;

FIG. 2 shows an enlarged depiction of the hinge connection from FIG. 1;

FIG. 3 shows a sealing arrangement of the hinge connection in a further enlarged extract from FIG. 2; and

FIG. 4 shows an O-ring of the sealing arrangement in an enlarged extract from FIG. 3.

### DESCRIPTION

The embodiments described below are not intended to be exhaustive or to limit the invention to the precise forms disclosed in the following description. Rather, the embodiments are chosen and described so that others skilled in the art may appreciate and understand the principles and practices of this disclosure.

It should be understood that the terms “horizontal” and “vertical” are generally used herein to establish positions of individual components relative to one another rather than an absolute angular position in space. Further, regardless of the reference frame, in this disclosure, terms such as “vertical,” “parallel,” “horizontal,” “right angle,” “rectangular” and the like are not used to connote exact mathematical orientations or geometries, unless explicitly stated, but are instead used as terms of approximation. With this understanding, the term “vertical,” for example, certainly includes a structure that is positioned exactly 90 degrees from horizontal, but should generally be understood as meaning positioned up and down rather than side to side. Other terms used herein to connote orientation, position or shape should be similarly interpreted. Further, it should be understood that various structural terms used throughout this disclosure and claims should not receive a singular interpretation unless it is made explicit herein. By way of non-limiting example, the terms “swivel leg,” “ring seal,” and “bearing bracket,” to name just a few, should be interpreted when appearing in this disclosure and claims to mean “one or more” or “at least one.” All other terms used herein should be similarly interpreted unless it is made explicit that a singular interpretation is intended.

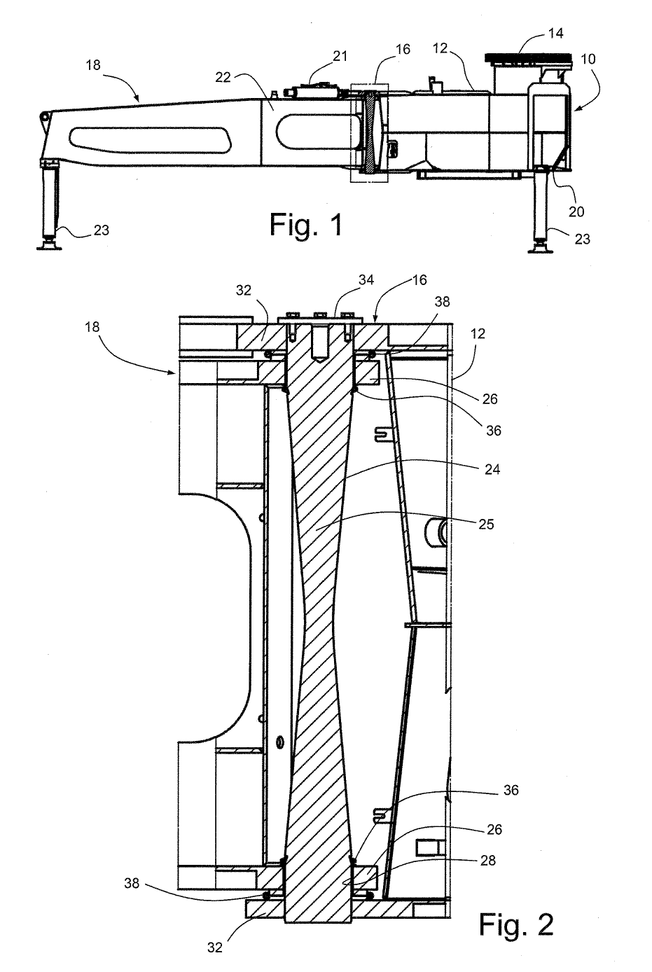

The truck-mounted concrete pump 10 shown only as an extract in FIG. 1 has a supporting structure 12 fixedly mounted on a chassis of a vehicle. The supporting structure 12 forms a bearing block 14 for a concrete distribution mast (not shown) rotatable about a vertical rotation axis, and which is connected in articulated fashion via a hinge connection or hinge point 16 onto two horizontally swiveling rear swivel legs 18 mounted on the long vehicle sides, while two front telescopic legs 20 can be extended telescopically. The legs 18, 20 can thus be brought from a travelling position into a supporting position further out from the vehicle longitudinal axis, in order to guarantee the safety and stability of the vehicle even on movements of the concrete distribution mast. The swivel legs 18 are swiveled outward via hydraulic cylinders 21 which act on the horizontal support leg arm 22. To compensate for unevenness of the ground, vertically extending hydraulic supporting cylinders 23 are arranged on the ends of the legs 18, 20 and are able to lift the chassis from the ground.

Each hinge point 16 of the swivel legs 18 has a swivel leg bolt 24 which is held on the supporting structure 12 and defines a vertical pivot axis. The swivel leg bolt 24 is tapered in its center region 25 in the manner of a double cone, as described in more detail in DE-A 102013205888. With regard to the general configuration of a truck-mounted concrete pump with supporting structure and distribution mast, reference is hereby made in full to DE-A 102013205888.

As shown most clearly from the axial section through the swivel leg bolt 24 in FIG. 2, each swivel leg 18 on its end close to the vehicle has two bearing brackets 26 which protrude in the manner of forks and are spaced vertically from each other, and which are mounted via co-aligned bearing eyes or bearing bores 28 on the cylindrical end portions 30 of the swivel leg bolt 24 so to be able to rotate horizontally. The two bearing brackets 26 have outsides facing away from each other and insides facing towards each other. The swivel leg bolt 24 is held at both ends on two retaining plates 32 which are fixedly connected to the supporting structure 12 and overlap in pairs with the bearing brackets 26, wherein an axle holder in the form of a covering end plate 34 bolted to the upper end face of the swivel leg bolt 24 ensures a rotationally stationary and axially displaceable fixing.

The bearing region formed by the annular cylindrical bearing gap between the swivel leg bolt 24 and the bearing brackets 26 is in each case sealed by flexible profiled ring seals 36, 38 so as to prevent the ingress of corrosive media. The elastically deformable profiled ring seals 36, 38 are here held under pretension in order to achieve an optimum sealing effect.

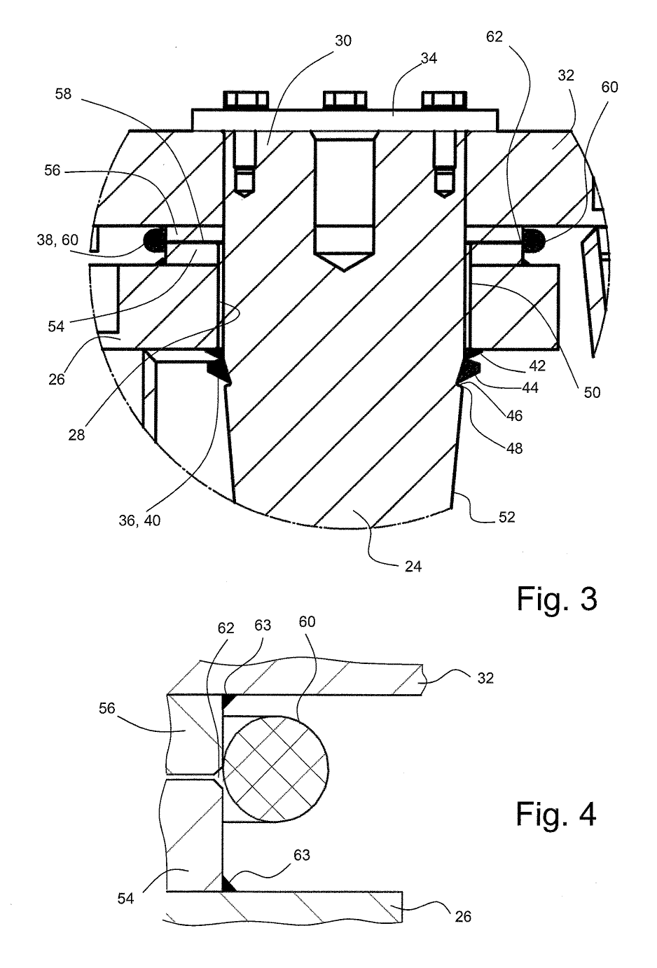

FIG. 3 shows an enlarged extract of the arrangement of the profiled ring seals 36, 38 on the upper end portion 30 of the swivel leg bolt 24. The lower end portion is sealed symmetrically to this. On the insides of the bearing brackets 26 facing each other, a fully rubberized V-ring 40 is arranged as a profiled ring seal 36 in a peripheral recess of the swivel leg bolt 24, wherein the profile of the V-ring 40 has a flexible sealing lip 42 pressing axially against the bearing bracket 26 and a supporting body 44 connected to the sealing lip 42 in the manner of a hinge, leaving a V-shaped gap. To secure the position, the V-ring 40 is drawn onto a conical sealing ring seat 46 which expands towards the bearing bracket 26 to be sealed, and has a stepped edge 48 in its tapered region facing away from this. This prevents the V-ring 40 from slipping into the small diameter region of the swivel leg bolt 24.

In the region between the swivel leg bolt 24 and the bearing bracket 26, a bearing bushing 50 is inserted between bright metal faces to improve the bearing properties. The V-ring 40 as a gap seal serves to seal against dirt, dust and water, and a mixture of these corrosive media. The sealing lip 42 allows a degree of axial play of for example 3 to 6 mm, so that the sealing effect is retained even under loads in travelling mode or on extension of the supporting cylinder 23. The chamfer of the supporting body 44, transforming into the conical region of the swivel leg bolt 24, supports the outflow of fluidic media. As already mentioned, the swivel leg bolt 24 in its cylindrical end portion 30 remains bright for reasons of fit precision, while the double conical center region has a paint layer 52 on the casing side for design reasons. Suitably, this paint layer 52 ends at a paint edge in the region of the conical sealing ring seat 46.

The bearing brackets 26 and retaining plates 32 are supported against each other in pairs by annular sliding disks 54, 56. On the periphery, these are fixed via weld seams to the respective adjacent connecting partner. An integral molding of sliding disks on the respective bearing brackets 26 or retaining plate 32 is also conceivable.

As shown in FIG. 4, the gap region 58 between the sliding disks 54, 56 is sealed by a further profiled ring seal 38 formed as an O-ring 60. Suitably, the sliding disks 54, 56 are chamfered on their peripheral edges adjacent to each other, and thus in the chamfer region form a sealing ring seat 62 for the O-ring 60. Further centering is achieved by fillet welds 63 with which the sliding disks 54, 56 are fixed rotationally stationarily to the bearing brackets 26 and retaining plate 32. The sliding disks 54, 56 indeed move relative to each other on extension of the swivel leg 18; the angular ranges are however small and the rotary movements slow and also infrequent. It was therefore found that a quasi-static sealing situation exists in which an O-ring can still be used without problems. In order to ensure a reliable radial sealing effect, the ring diameter of the O-ring 60 is selected significantly smaller (e.g. by 10 mm) than the diameter of the sliding disks 54, 56, so that it sits under a strong pretension in the installation position. The profile diameter of the O-ring 60 is dimensioned sufficiently large to be able to seal the axial expansions of the gap region 58 occurring at any time during travel and in pumping mode.

The two profiled ring seals 36, 38 consist of nitrile rubber which has a high flexibility, elasticity and resistance to weather, oil and solvents, and the properties of which can be optimized further by suitable application-specific additives.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

What is claimed is:

1. A mobile work machine, comprising:
a supporting structure configured to be secured to a vehicle and configured for supporting a concrete distribution mast;
a swivel leg hingedly connected to the supporting structure, the swivel leg having a protruding bearing bracket rotatably mounted via a bearing bore onto a swivel leg bolt fixed to the supporting structure, wherein the swivel leg is horizontally rotatable;
a bearing region located between the swivel leg bolt and the bearing bracket; and
a profiled ring seal sealing the bearing region.

2. The mobile work machine as claimed in claim 1, wherein the profiled ring seal is held under pretension in a sealing ring seat.

3. The mobile work machine as claimed in claim 1, wherein the profiled ring seal is held on the bearing bracket in a peripheral recess formed on the swivel leg bolt.

4. The mobile work machine as claimed in claim 1, wherein the bearing region comprises a cylindrical bearing gap between the bearing bracket and the swivel leg bolt.

5. The mobile work machine as claimed in claim 1, wherein the profiled ring seal comprises a V-ring.

6. The mobile work machine as claimed in claim 5, wherein the V-ring has a sealing lip configured to be pressed against the bearing bracket.

7. The mobile work machine as claimed in claim 1, wherein the swivel leg bolt on an end portion thereof has a sealing ring seat that widens conically toward the bearing bracket.

8. The mobile work machine as claimed in claim 7, wherein the ring seat has a stepped edge on a flank facing away from the bearing bracket.

9. The mobile work machine as claimed in claim 7, wherein the swivel leg bolt is coated with a paint coating that ends at the ring seat.

10. The mobile work machine as claimed in claim 1, wherein the swivel leg bolt is held at an end thereof with a retaining plate configured to be fixed to the vehicle and an O-ring seal is arranged between the retaining plate and the bearing bracket.

11. The mobile work machine as claimed in claim 10, wherein the retaining plate and bearing bracket are supported against each other by two sliding disks having a gap region therebetween, the gap region being sealed by the O-ring.

12. The mobile work machine as claimed in claim 11, wherein the sliding disks are chamfered on adjacent peripheral edges to define an O-ring sealing seat for the O-ring seal.

13. The mobile work machine as claimed in claim 1, wherein a bearing bushing is disposed in the bearing bore.

14. The mobile work machine as claimed in claim 1, wherein:
the swivel leg bolt comprises two cylindrical end portions and a center portion, the swivel leg bolt widening as a double cone towards the end portions; and
the profiled ring seal comprises two profiled ring seals, each profiled ring seal arranged in a respective transitional region between the center portion and a respective one of the end portions.

15. The mobile work machine as claimed in claim 1, wherein the profiled ring seal is formed of a nitrile rubber.

16. The mobile work machine as claimed in claim 1, wherein the bearing bracket comprises two bearing brackets.

17. The mobile work machine as claimed in claim 16, wherein the profiled ring seal comprises two profiled ring seals arranged on mutually facing insides of the two bearing brackets.
